(19) United States
(12) Patent Application Publication
(10) Pub. No.: US 2016/0063659 A1
(43) Pub. Date: Mar. 3, 2016

(54) Electronic Device Display With Electrostatic Discharge Recovery Capabilities

(71) Applicant: Apple Inc., Cupertino, CA (US)

(72) Inventors: Mohammad Ali Jangda, San Jose, CA (US); Sang Y. Youn, Cupertino, CA (US); Wei H. Yao, Palo Alto, CA (US); Hyunwoo Nho, Stanford, CA (US); Arthur L. Spence, San Jose, CA (US); Viswa B. Pilla, Mountain View, CA (US); Axel B. Schumacher, San Francisco, CA (US); Ramachandran Chundru, Cupertino, CA (US)

(21) Appl. No.: 14/841,544

(22) Filed: Aug. 31, 2015

Related U.S. Application Data
(60) Provisional application No. 62/044,543, filed on Sep. 2, 2014.

(51) Int. Cl. G06T 1/00; G06T 1/60; G09G 3/00

(52) U.S. Cl. CPC G06T 1/00; G09G 3/006; G06T 1/60; G09G 2300/04; G09G 2310/08

(57) ABSTRACT

An electronic device may be provided with a housing such as a metal housing in which a display is mounted. Control circuitry in the electronic device such as a system-on-chip integrated circuit may produce image data. A display driver integrated circuit may receive the image data from the system-on-chip integrated circuit and may display the image data on the display. In the absence of electrostatic discharge, the display driver integrated circuit may operate normally and may generate a heartbeat signal. When disrupted due to electrostatic discharge, the display driver circuitry may cease production of the heartbeat signal. The system-on-chip integrated circuit can implement a watchdog timer. If the watchdog timer times out because the heartbeat signal is not received within a timeout period, the system-on-chip integrated circuit may reset the display.

This application claims priority to U.S. provisional patent application No. 62/044,543, filed Sep. 2, 2014, which is hereby incorporated by reference herein in its entirety.

### BACKGROUND

This relates generally to electronic devices and, more particularly, to electronic devices with displays.

Electronic devices often include displays. Processing circuitry in a device generates image data to be displayed. Display driver circuitry is used to control the pixels in a display so that the image data can be displayed. The display driver circuitry typically includes a display driver integrated circuit.

Electrostatic discharge (ESD) events may occur when a user handles an electronic device. As a consequence, electrostatic charges may build up on internal device components or ESD current may flow through their internal pins and traces. If care is not taken, components such as display driver integrated circuits may be disrupted.

It may be difficult or impossible to incorporate satisfactory electric or magnetic field shielding layers in an electronic device to prevent disruption of a display during electrostatic discharge events. For example, although an opaque metal shield placed in front of a display might help shield the display from electrostatic charge, it is not possible to place an opaque metal shield over the front of the display without blocking the display from view by a user. Internal shielding layers and ground paths that do not cover the front of the display may be insufficient to prevent electrostatic charge from migrating from exposed portions of a display to sensitive internal circuits such as display driver circuits.

It would therefore be desirable to be able to provide an electronic device with a display that is able to recover from electrostatic discharge events.

### SUMMARY

An electronic device may be provided with a housing such as a metal housing in which a display is mounted. Control circuitry in the electronic device such as a system-on-chip integrated circuit may produce image data. A display driver integrated circuit may receive the image data from the system-on-chip integrated circuit and may display the image data on the display. In the absence of electrostatic discharge, the display driver integrated circuit may operate normally and may generate a heartbeat signal. When disrupted due to electrostatic discharge, the display driver circuitry may cease production of the heartbeat signal. The system-on-chip integrated circuit can be used to implement a watchdog timer. If the watchdog timer times out because the heartbeat signal is not received within a predetermined timeout period, the system-on-chip integrated circuit may reset the display.

The system-on-chip integrated circuit may have a frame buffer that contains the image data that is to be displayed on the display. During reset operations, the system-on-chip integrated circuit may freeze the image data in the frame buffer to preserve this image data. After freezing the image data in the frame buffer, the system-on-chip integrated circuit may reset the display by turning off the display driver integrated circuit, turning on the display driver integrated circuit, and configuring the display driver integrated circuit by loading a register in the display driver integrated circuit with display driver integrated circuit settings. The frozen image frame may then be retrieved and provided to the display driver integrated circuit.

### BRIEF DESCRIPTION OF THE DRAWINGS

FIG. 1 is a perspective view of an illustrative electronic device with a display in accordance with an embodiment.

FIG. 2 is a schematic diagram of an illustrative electronic device with a display in accordance with an embodiment.

FIG. 3 is a flow chart of illustrative steps involved in operating an electronic device of the type shown in FIGS. 1 and 2 in accordance with an embodiment.

### DETAILED DESCRIPTION

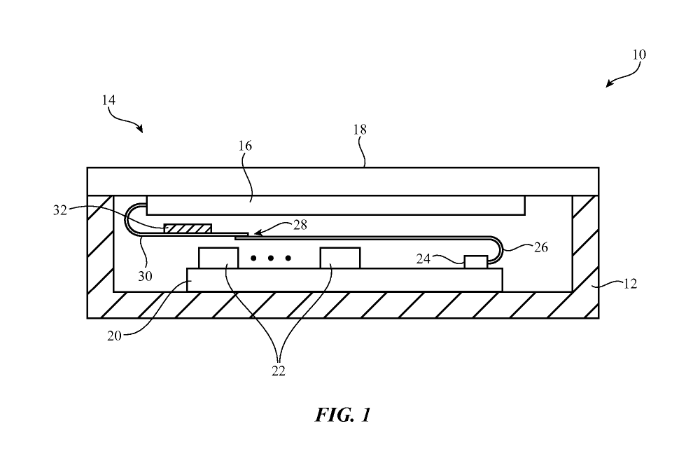

A cross-sectional side view of an illustrative electronic device of the type that may include a display and other electrical components is shown in FIG. 1. Electronic device 10 may be a computing device such as a laptop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment. In the illustrative configuration of FIG. 1, device 10 is a small portable device such as a cellular telephone, media player, tablet computer, wristwatch device, pendant device, or other portable computing device. Other configurations may be used for device 10 if desired. The example of FIG. 1 is merely illustrative.

In the example of FIG. 1, device 10 includes a display such as display 14. Display 14 has been mounted in a housing such as housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.).

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures.

Display 14 may include an array of pixels formed from liquid crystal display (LCD) components, an array of electrophoretic pixels, an array of plasma pixels, an array of organic light-emitting diode pixels, an array of electrowetting pixels, an array of micro-light-emitting diodes, or pixels based on other display technologies.

Display 14 may be protected using a display cover layer such as display cover layer 18. Display cover layer 18 may be a clear layer of material such as a layer of transparent glass, sapphire or other crystalline materials, clear plastic, transparent ceramic, other transparent materials, or combinations of these materials. Openings may be formed in the display cover layer. For example, openings may be formed in the display cover layer to accommodate buttons, speakers, or other components. Openings may be formed in housing 12 to form communications ports (e.g., an audio jack port, a digital data port, etc.). Openings in housing 12 may also be formed for audio components such as a speaker and/or a microphone or other components.

Display 14 may include a display module such as display module 16 that is mounted under the inner surface of display cover layer 18. Display module 16 may be a liquid crystal display (LCD) module, an array of electrophoretic pixels, a layer of plasma pixels, an array of organic light-emitting diode pixels, an array of electrowetting pixels, or one or more display layers based on other display technologies.

Device 10 may include substrates with signal lines. For example, device 10 may include one or more printed circuits. Printed circuits in device 10 may include rigid printed circuits (e.g., printed circuits formed from fiberglass-filled epoxy or other rigid printed circuit board material) and flexible printed circuits (e.g., printed circuits formed from flexible substrate materials such as flexible sheets of polyimide or layers of other flexible polymers). As shown in FIG. 1, components 22 may be mounted on printed circuit 20. Printed circuit 20 may be a rigid printed circuit or a flexible printed circuit. Components 22 may include one or more integrated circuits or other electrical components. Components 22 may, for example, include storage such as hard disk drive storage, nonvolatile memory (e.g., flash memory or other electrically-programmable-read-only memory configured to form a solid state drive), volatile memory (e.g., static or dynamic random-access-memory), etc. Components 22 may also include processing circuitry that is used to control the operation of device 10. This processing circuitry may be based on one or more microprocessors, microcontrollers, digital signal processors, baseband processor integrated circuits, application specific integrated circuits, a system-on-chip integrated circuit, etc.

The control circuitry of device 10 (e.g., the storage and processing circuitry formed from components such as components 22 on printed circuit 20) may be used to run software on device 10 such as internet browsing applications, voice-over-internet-protocol (VOIP) telephone call applications, email applications, media playback applications, operating system functions, game applications, maps, etc. During operation, the circuitry of device 10 may gather input from input-output devices and may supply output (e.g., to a user or to an electronic device) using input-output devices. These input output devices may include user interface devices, data port devices, and other input-output components. For example, the input-output devices of device 10 may include touch screens, displays without touch sensor capabilities, buttons, joysticks, scrolling wheels, touch pads, key pads, keyboards, microphones, cameras, speakers, status indicators, light sources, audio jacks and other audio port components, digital data port devices, light sensors, accelerometers or other components that can detect motion and device orientation relative to the Earth, capacitance sensors, proximity sensors (e.g., a capacitive proximity sensor and/or an infrared proximity sensor), magnetic sensors, a connector port sensor or other sensor that determines whether device 10 is mounted in a dock, and other sensors and input-output components. Wireless communications circuitry (e.g., antennas, transceivers, etc.) may be used to send and receive wireless signals.

The circuitry on printed circuit 20 may include a system-on-chip (SOC) integrated circuit, application-specific integrated circuits, microprocessors, memory, and other control circuits that generate image data to be displayed on display 14. Image data from the system-on-chip integrated circuit or other control circuit may be supplied to display driver integrated circuit 32 using flexible printed circuit 26 and flexible printed circuit 30. Flexible printed circuit 26 may be coupled to printed circuit 20 using board-to-board connector 24 or other suitable connection. Flexible printed circuit 26 may be coupled to flexible printed circuit 30 using electrical connection 28. Connection 28 may be formed using one or more connectors, solder joints, welds, anisotropic conductive adhesive connections or other conductive adhesive connections, or other electrical connections. Using signal paths such as metal traces in flexible printed circuits 26 and 30, control circuitry in components 22 (e.g., a system-on-chip integrated circuit, etc.) can supply image data to display driver circuitry 32. Display driver circuitry 32 can receive and process this image data and can generate corresponding data line signals and other signals for controlling the operation of the array of pixels in display module 16.

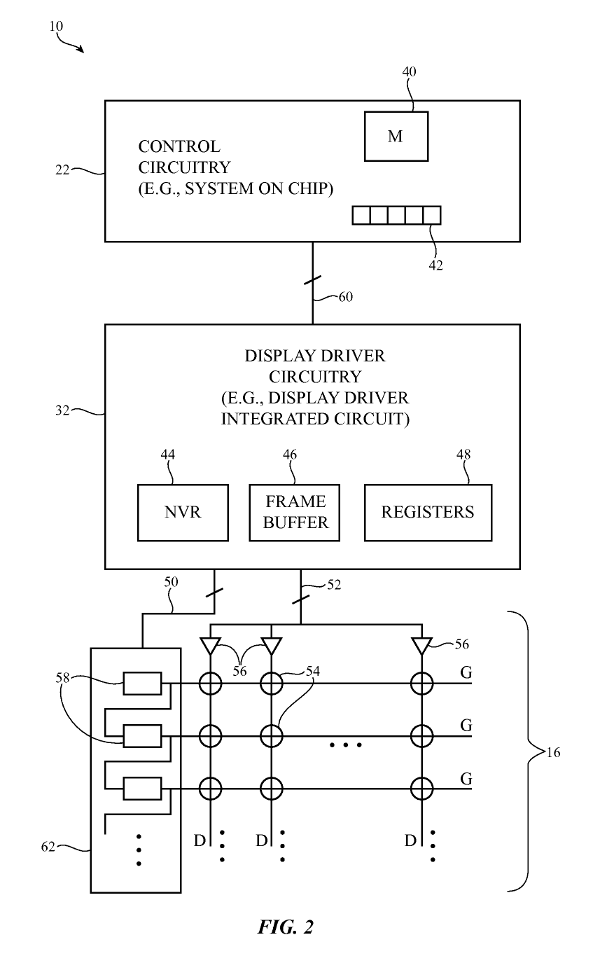

FIG. 2 is a schematic diagram of electronic device 10 showing how control circuitry 22 may communicate with display driver circuitry 32 over communications path 60. Control circuitry 22 may be based on one or more integrated circuits. For example, control circuitry 22 may be based on a system-on-chip integrated circuit having memory 40 and frame buffers 42. During operation, the processing circuitry of control circuitry 22 can generate frames of image data to display on display 14 of FIG. 1. The frames of image data may be stored in frame buffer 42 and may be transmitted to display driver circuitry 32 over path 60. The system-on-chip integrated circuit and other circuits in control circuitry 22 may include memory 40 for storing display settings, digital image data, code to execute to implement timers and other control features, etc.

Communications path 60 may be formed by signal lines in printed circuits such as printed circuits 20, 26, and 30 of FIG. 1. The signal lines may be formed from patterned metal traces. Printed circuits 20, 26, and 30 may be single layer printed circuits or may be multilayer printed circuits. If desired, the circuitry mounted on printed circuits 20, 26, and 30 of FIG. 1 may be mounted on fewer printed circuits or on a larger number of printed circuits. The configuration of FIG. 1 is merely illustrative.

Display driver circuitry 32 may include memory such as non-volatile memory 44. Non-volatile memory 44 may be used to retain display driver integrated circuit settings for display 14 in situations in which power has been removed from display driver circuitry 32. During display startup operations, display settings may be retrieved from non-volatile memory 44 and loaded into registers 48. The data in registers 48 may also be updated (e.g., by using control circuitry 22 to load updated settings from memory 40). Frame buffer 46 may be loaded with image frames received from frame buffer 42 over path 60. The image data in frame buffer 46 may be displayed on the array of pixels 54 in display module (array) 16.

As shown in FIG. 2, display module 16 may include an array of pixels 54 that are arranged in rows and columns. Other patterns of pixels may be used if desired. Each column of pixels 54 may be provided with data signals over a corresponding vertical data line D. Data line drivers 56 may strengthen data line signals received from display driver circuitry 32 over paths 52. Gate driver circuitry 62 may receive clock signals and other control signals from display driver circuitry 32 over path 50. Gate driver circuitry 62 may include shift register circuitry and output drivers coupled in a chain along one or more edges of display 14 (see, e.g., register and driver circuits 58). Thin-film transistor circuitry may be used to implement data line drivers 56 and gate driver circuitry 62 or some or all of this circuitry may be implemented using integrated circuits.

During operation, the signals on horizontal control lines such as gate lines G are asserted in sequence (row-by-row) while data for corresponding rows of pixels 54 is being supplied to the array of display module 16 by display driver circuitry 32 over data lines D. If electrostatic charge is present in the vicinity of display driver circuitry 32 due to the occurrence of an electrostatic discharge event (e.g., when a user operates device 10 in an environment that is susceptible to static electricity), that charge can disrupt display driver circuitry 32. This may prevent display driver circuitry 32 from regularly asserting the gate lines signals on gate lines G, may prevent display driver circuitry 32 from supplying proper data line signals on data lines D, and may prevent display driver circuitry 32 from performing other operations associated with displaying the image data from control circuitry 22 on display module 16.

To ensure that device 10 and display 14 can continue to operate satisfactorily, even in the presence of a static discharge event, device 10 may continually monitor for the proper operation of display driver circuitry 32. In the event that normal operation is disrupted, corrective action can be taken. As an example, control circuitry 22 may reset display 14 so that image data from frame buffer circuitry 42 can be displayed on display 14 after the electrostatic discharge event has passed.

With one suitable arrangement, display driver circuitry 32 (e.g., a display driver integrated circuit) generates a periodic output signal, sometimes referred to as a heartbeat signal. The heartbeat signal may be produced by the display driver circuitry so long as the operation of the display driver circuitry is not disrupted by electrostatic discharge. The display driver circuitry will, however, cease to produce the heartbeat signal when disrupted by electrostatic discharge.

Control circuitry 22 may monitor for the presence of the heartbeat signal and may reset a watchdog timer each time a heartbeat signal is satisfactorily received. If the timer expires (times out) without receiving a heartbeat signal, control circuitry 22 may conclude that proper operation of display driver circuitry 32 has been disrupted by an electrostatic discharge event. Control circuitry 22 may then reset display 14 by power cycling display module 16 or may take other suitable action to recover display 14 from the electrostatic discharge disruption.

The heartbeat signal may be generated by display driver circuit 32 at any suitable frequency. As an example, the heartbeat signal may be generated at a frequency of 1 Hz or more, 2 Hz or more, 5 Hz or more, 10 Hz or more, 20 Hz or more, 60 Hz or less, less than 20 Hz, less than 10 Hz, less than 5 Hz, etc. Low heartbeat signal frequencies may be associated with reduced power consumption by the circuitry of device 10. Accordingly, it may be desirable for display driver circuitry 32 to generate a heartbeat signal at a relatively low frequency. At the same time, care must be taken that the heartbeat signal is not too slow. An excessively slow heartbeat signal might cause control circuitry 22 to wait unnecessarily before being able to determine the state of display driver circuitry 32. It may therefore be desirable to ensure that the period of the heartbeat signal is no longer than the maximum acceptable display recovery time for display 14 in the event of an electrostatic discharge event.

If desired, display 14 may implement a variable refresh rate scheme. With a variable refresh rate display configuration, the rate at which display driver circuitry 32 displays frames of image data on display module 16 (e.g., the array of pixels 54) is varied dynamically to conserve power. In situations in which a video clip or other content with rapidly changing image frames is being presented, display driver circuitry 32 may display images at a relatively high rate (e.g., 60 Hz). This will ensure smooth playback of the image data. In situations in which a static menu, photo, or other slowly changing image data is being display, it is not necessary to frequently refresh the images on display module 16. In this type of situation, display driver circuitry 32 may reduce the refresh rate being used for display 14 (e.g., to a relatively slow rate such as less than 10 Hz, less than 2 Hz, etc.). It may be desirable to use a constant heartbeat frequency in the event that a variable refresh rate is used (e.g., to help ensure that control circuitry 22 does not make erroneous conclusions about whether electrostatic discharge has disrupted display driver circuitry 32).

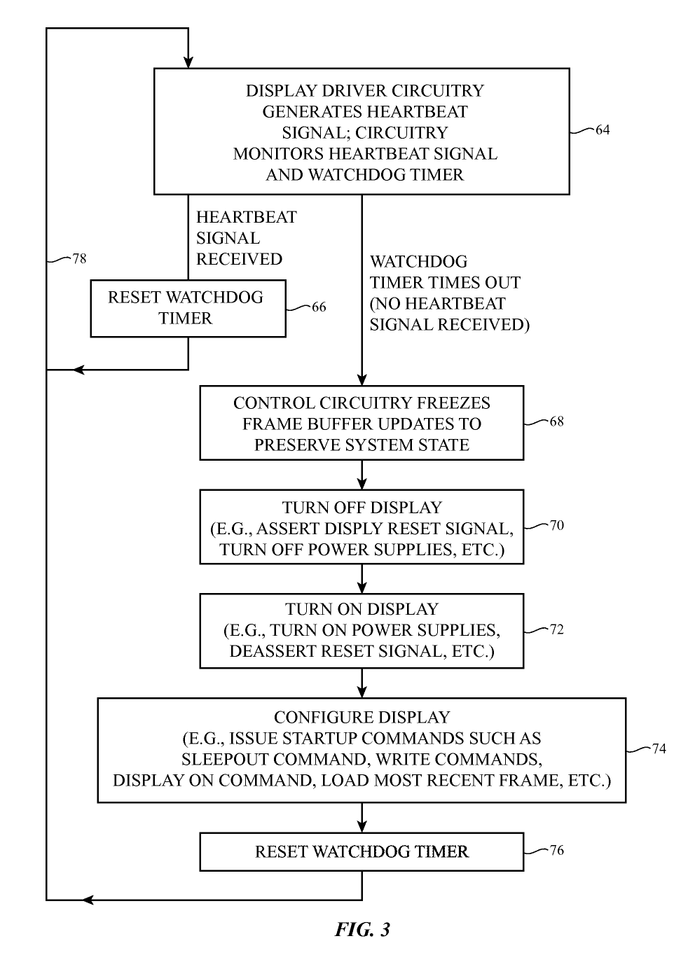

FIG. 3 is a flow chart of illustrative steps involved in operating device 10 in an environment where electrostatic discharge events have the potential to disrupt operation of display driver circuitry 32. At step 64, display driver circuitry 32 may generate a periodic heartbeat signal. At the same time, control circuitry 22 continuously decrements a countdown timer (sometimes referred to as a watchdog timer) while monitoring for the expected occurrence of the heartbeat signal. Heartbeat signals may be conveyed from display driver circuitry 32 to control circuitry 22 over path 60.

During normal operation of display driver circuitry 32, display driver circuitry 32 will not be disrupted by electrostatic discharge and will function as expected. In this scenario, display driver circuitry 32 will satisfactorily generate the heartbeat signal according to its established heartbeat signal frequency. The watchdog timer that is implemented by control circuitry 22 has a period based on the known frequency (period) of the heartbeat signal. If, for example, the frequency of the heartbeat signal is 10 Hz, a heartbeat signal will be expected by control circuitry 22 every 0.1 s. Accordingly, the watchdog timer will be considered to have timed out if no heartbeat signal has been received within 0.1 s (i.e., the expiration period of the watchdog timer is about 0.1 s in this example).

As shown in FIG. 3, in response to successful receipt at control circuitry 22 of the heartbeat signal generated by display driver circuitry 32, control circuitry 22 may, at step 66, reset the watchdog timer (i.e., the countdown value for the timer will be reset to its initial value). Control may then loop back to step 64, as indicated by line 78.

If, during the operations of step 64, control circuitry 22 determines that the watchdog timer has expired without receiving a heartbeat signal from display driver circuitry 32, control circuitry 22 can conclude that an electrostatic discharge event has disrupted normal operation of display driver circuitry 32. In response, control circuitry 32 can cease making normal updates to frame buffer 42 in control circuitry 22 (step 68), so that image data will be preserved during the process of resetting display 14.

At step 70, control circuitry 22 may turn off display 14 (i.e., circuitry 22 may turn off display driver integrated circuit 32). For example, control circuitry 22 may assert a display reset signal on a display driver integrated circuit reset line within path 60 and may depower the circuitry of display driver circuitry 32.

Display driver circuitry 32 may be powered using one or more power supplies. For example, display driver circuitry 32 may contain a digital logic core for handling communications and control functions. This digital logic core may be supplied with a “digital” power supply. Display driver circuitry 32 may also include analog circuitry for generating gate driver control signals on path 50 and data line signals on path 52. These analog circuits can be powered using one or more “analog” power supplies. During the operations of step 70 (e.g., after the reset signal has been asserted), control circuitry 22 may turn off the analog power supplies and the digital power supply for display driver circuitry 32 (e.g., the analog power supply lines may be depowered first and the digital power supply line may be depowered second). These operations turn off display module 16 (e.g., the pixel array formed from pixels 54 will be depowered).

At step 72, control circuitry 22 may turn on display 14 (i.e., circuitry 22 may turn on display driver integrated circuit 32). For example, control circuitry 22 may turn on a digital power supply and, after the digital power supply has been activated, may turn on each analog power supply. After the digital and analog power supplies have been turned on, control circuitry 22 may deassert the reset signal on the display driver circuitry reset line in path 60.

The process of turning off display 14 at step 70 and turning display 14 back on at step 72 may sometimes be referred to as power cycling the display. These operations help reset the display so that the display will no longer be adversely affected due to the presence of electrostatic charge.

After turning on the display at step 72, the display (display driver integrated circuit 32) may be configured at step 74. For example, control circuitry 22 may issue MIPI (Mobile Industry Processor Interface) display startup commands or other commands to reset display 14. The commands may include a sleep out command. The sleep out command directs display driver circuitry 32 to load default display driver settings into settings registers 48 from non-volatile memory 44. After the sleep out command has been issued, control circuitry 22 may issue one or more write commands to update the display driver settings. For example, write commands may be used to load updated settings into registers 48 from memory 40 or other suitable storage. Control circuitry 22 may then issue a display on command and may load appropriate image data (e.g., the last image frame, which was frozen in frame buffers 42) into frame buffer 46. This allows display 14 to be nearly seamless in its display of image data. During the reset process, display 14 may momentarily go blank and then, following the operations of steps 68, 70, 72, and 74, display 14 may continue to display the previously displayed image frame.

Because the display has been reset following the display recovery operations of steps 68, 70, 72, and 74, control circuitry 22 may reset the watchdog timer of control circuitry 22 at step 76. As indicated by line 78, control may then return to step 64, where display 14 can be used to display data normally for a user of device 10.

The foregoing is merely illustrative and various modifications can be made by those skilled in the art without departing from the scope and spirit of the described embodiments. The foregoing embodiments may be implemented individually or in any combination.

What is claimed is:

1. An electronic device, comprising:
a display;
control circuitry that produces image data and that implements a watchdog timer; and
display driver circuitry that displays the image data on the display, wherein the display driver circuitry produces a heartbeat signal when not disrupted by electrostatic discharge and ceases to produce the heartbeat signal when disrupted by electrostatic discharge and wherein the control circuitry resets the display when the watchdog timer times out without receiving the heartbeat signal.

2. The electronic device defined in claim 1 wherein the control circuitry is configured to turn off the display when resetting the display.

3. The electronic device defined in claim 2 wherein the control circuitry is configured to turn on the display after having turned off the display when resetting the display.

4. The electronic device defined in claim 3 wherein the control circuitry is configures the display after turning off and on the display.

5. The electronic device defined in claim 4 wherein the display comprises an array of pixels selected from the group consisting of: light-emitting diode display pixels and liquid crystal display pixels.

6. The electronic device defined in claim 4 wherein the display comprises an organic light-emitting diode display.

7. The electronic device defined in claim 6 further comprising:
a metal housing, wherein the display is mounted to the metal housing.

8. The electronic device defined in claim 7 wherein the display driver circuitry is a display driver integrated circuit.

9. The electronic device defined in claim 8 wherein the control circuitry is a system-on-chip integrated circuit.

10. The electronic device defined in claim 9 further comprising:
a first printed circuit on which the system-on-chip integrated circuit is mounted, a second printed circuit that is coupled to the first printed circuit using a connector, and a third printed circuit that is coupled between the second integrated circuit and the display, wherein the display driver integrated circuit is mounted on the third printed circuit.

11. A method of operating a display in an electronic device that has control circuitry that generates image data and display driver circuitry that displays the image data on the display, the method comprising:
producing a heartbeat signal with the display driver circuitry when the display driver circuitry is not disrupted by electrostatic discharge;
ceasing production of the heartbeat signal by the display driver circuitry in response to disruption of the display driver circuitry by electrostatic discharge; and
resetting the display with the control circuitry in response to determining that a watchdog timer has timed out without receiving the heartbeat signal at the control circuitry.

12. The method defined in claim 11 wherein resetting the display comprises turning off the display driver circuitry.

13. The method defined in claim 12 wherein resetting the display comprises turning on the display driver circuitry after turning off the display driver circuitry.

14. The method defined in claim 12 wherein resetting the display comprises configuring the display driver circuitry after turning off and turning on the display driver circuitry.

15. The method defined in claim 12 wherein turning off the display driver circuitry comprises asserting a display driver integrated circuit reset signal and turning off display driver integrated circuit power supplies.

16. The method defined in claim 15 wherein turning on the display driver circuitry comprises turning on the display driver integrated circuit power supplies and deasserting the display driver integrated circuit reset signal.

17. The method defined in claim 16 wherein the control circuitry includes a frame buffer and wherein resetting the display further comprises:
freezing the image data in the frame buffer before turning off the display driver circuitry.

18. The method defined in claim 17 wherein resetting the display comprises loading display driver integrated circuit settings into a register in the display driver circuitry after turning on the display.

19. The method defined in claim 18 wherein resetting the display comprises loading the frozen image data from the frame buffer in the control circuitry into the display driver circuitry after turning on the display driver circuitry.

20. An electronic device, comprising:
a metal housing;
a display mounted to the metal housing;
a system-on-chip integrated circuit in the metal housing that produces image data and that implements a watchdog timer; and
a display driver integrated circuit that displays the image data on the display by supplying signals to data lines in the display, wherein the display driver integrated circuit produces a heartbeat signal when not disrupted by electrostatic discharge and ceases to produce the heartbeat signal when disrupted by electrostatic discharge and wherein the system-on-chip integrated circuit resets the display when the watchdog timer times out without receiving the heartbeat signal.

21. The electronic device defined in claim 20 wherein the display comprises an organic light-emitting diode display and wherein the display driver integrated circuit is mounted on a flexible printed circuit that is coupled to the organic light-emitting diode display.
